(19) United States
(12) Patent Application Publication
(10) Pub. No.: US 2004/0069592 A1
(43) Pub. Date: Apr. 15, 2004

(54) Instant public phone degerminator

(76) Inventor: Bernice Stephens McQueen, Freeport, NY (US)

Correspondence Address: Bernice Stephens, 13 High Place, Freeport, NY, 11520, US

(21) Appl. No.: 10/270,214

(22) Filed: Oct. 15, 2002

(51) Int. Cl. G07F 1/00

(52) U.S. Cl. 194/353

(57) ABSTRACT

The abstract of my disclosure is new in the art of degerminating the mouthpiece of the public telephone. This is new because there is now no cleanser or germ erasing mechanism that can eradicate the germs from the public phones mouthpiece. With this new technology, one can now feel better that the germs usually present on the mouthpiece can be eradicated by the cleansing pad that I have invented to erase the germs from the mouthpiece at the telephone stations for convenient usage.

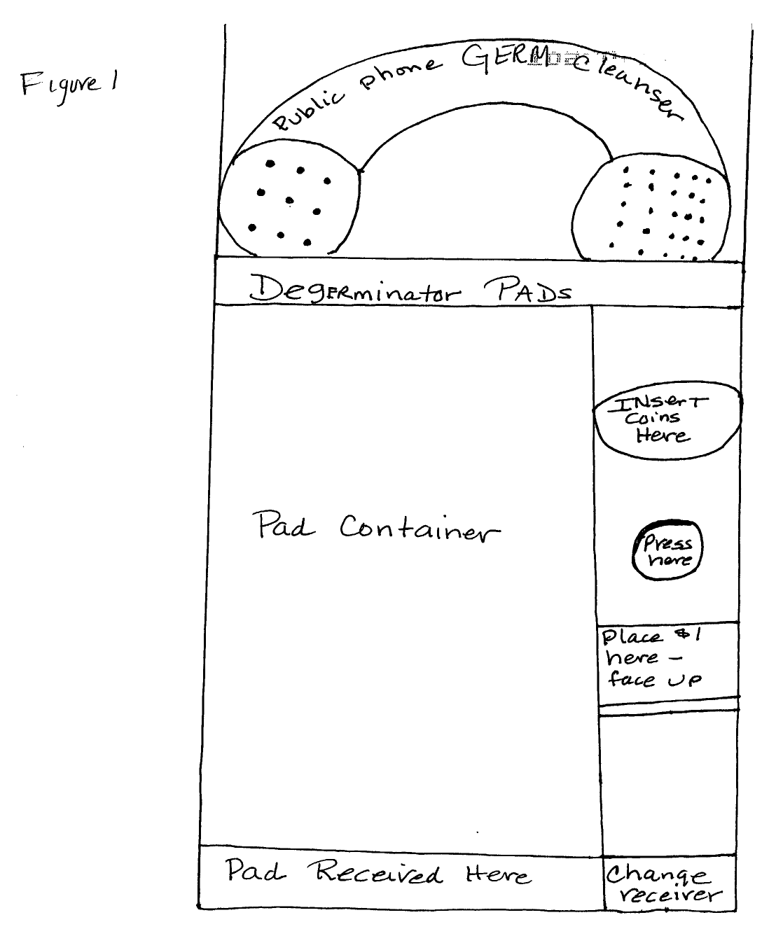

### BACKGROUND OF THE INVENTION

The field of endeavor to which my invention pertains is a cleaner communication system, namely; degerminating public phones instantly before using & alleviating the possibility of leaving, spreading, or picking up germs while using public phones.

The public phones are stationed in every city's airports, hotels, restaurants, malls, churches, casinos, bars, laundromats, schools, colleges & universities, hospitals emergency rooms, (just to name a few) and are being used over and over again without properly be treated against the spread of one person's germ to the next person.

A reference to a specific document is that the public telephones now are some time as filthy as you can not believe them to be. Sometimes I have to bypass one to go to another because it just looks like you can just see the filth on the mouthpiece of some public phones. I believe if I used a particular filthy looking phone that I would catch germs and spread them elsewhere before I got home. For instance, kissing a little baby after talking on a fifthy phone.

The problems involved here is all it takes is just one swipe of my degerminator pad and this will alleviate the germs. The problem here is the germs are left behind after each user of the public phones. This is unhealthy and unsanitary for America and countries Abroad. These germs can lead into some other unhealthy problems that's probably never known to the individual. These germs can be millions, and can be from so many different people and be different kinds of germs transferring all over the mouthpiece of the public phones that can not be detected by the natural eye.

### BRIEF SUMMARY OF THE INVENTION

The general idea of my invention is to help American and other people in this beautiful world to stay as healthy as possible, by reducing germ transference while using the public phone systems. Also, to stay as healthy as possible without a lot of inconveniences in this all-too-fast economy and have a peace of mind for our well being.

The advantages of this invention are:

(1) Solves the problem of picking up, spreading, or transferring germs

(2) Germ eradicator

(3) Cleanser

(4) Nothing to carry, the phone system itself will contain my degerminating pads for as little as $0.50 or so per pad with the dispenser displayed right beside the public phone.

(5) Sanitary

(6) Have the option of buying my degerminator in a container w/o having to have pocket change at the phone system

(7) A small container can clean approximately 20 phones, all you do is spray & wipe with the pad sold with the container in a neat package.

(8) Promotes a good feeling while taking on the phone that's you've used the degerminator.

The object of my invention is to keep America and other countries in the healthiest form possible, by doing all we can to alleviate grim causing situations.

Problems Solved:

Eradicates germs transference.

### BRIEF DESCRIPTION OF THE DRAWING

My invention consists of a small clever device positioned right beside or next to the public phone. This device is approximately 12″ long and 6″ wide. It can be longer or wider depending on the space available at the phone system station. A picture of an actual phone is at the top of this device with lettering printed “Public phone GERM cleanser”. Also, under this is the wording “Degerminator Pads”. This device contains up to 100 pads per machine with a change receiver for dispensing change after each transactions if needed. There is also an input slot for coins and $1 bills. One receives a pad by pressing “press here” button and pad is dropped into the received area at the bottom of the device. This device is built into the walls of the area next to the same space for the public telephone and has no detachment just like the public phone has no detachment used against thievery. It is compact, durable and easy to handle with no frustration or complication. The pads are easy to open with arrow pointing at opening edge and a public receptacle will be available at the site of each public phone station.

### DETAILED DESCRIPTION OF THE INVENTION

The public phone degerminator is my design of a germ eradicating pad that's used to erase germs from the mouthpiece of the public telephones after used from one person to another.

This inventoin is new and unheard of in the public phone sector. The pad content will consist of no harsh chemicals and will be examined closely and put together by my licensed chemists and approved by medical doctors licensed in the appropriate field to make and enhance the most revolutionary germ eradicator on planet earth. The cost of this pad is from $0.50 to $1.00.

The public phones now are sometime dirty and always carry its germs because of its use from one person to the next. With the world already in a state of concern about other matters, this degerminator can lessen the fear of germ catching that are associated with the use of public phone usage from one person to another. This is unsanitary and does not promote an healthy environment. Sometimes there are some things in the environment that we can not help inhaling just by stepping out of our homes. But if we can help ourselves by dispensing a little pad to cut our chances of catching germ, this is not a concept for a rocket scientist alone to catch a hold to. Any normal person should be willing to grasp this concept at the thought of knowing that it exist for them at the public phone stations.

The improvement is the uniqueness of something new. It is good for America. It is a revolutionary pad that will do for us what has never been done at the public telephone stations around the world. Feeling healthy about oneself have to make one feel better, think and act better toward one's self.

This device will consist of a picture of a phone with the wording “Public phone GERM cleanser. This is at the very top of the device to alert users of its existence at their fingertip NOW.

This device has across the top the word Degerminator Pads. The Pad Container is at the left of the device, and the receiver of the pads at the bottom of the device. The opening to the right of the device is for coins insert, and the press here button is under this slot in order to receive the pad. Also to the right is the option to use the dollar slot entrance instead of using coins. At the bottom of the machine is the change receiver of over input of currency.

1. What I claim as my invention is the “public phone degerminator”, which is my design of a germ eradicating pad to erase germs from the public phones mouthpiece that are being used by different people, to promote a healthier environment to enable us to feel better, think well and act better toward ourselves and at the same time decrease the number of germs that could be transferred from one person to the next person by using this device, which contains the following parts to bring about this change, i.e. a container containing the antibacterial pads, the slot for currency, the change dispenser, and the dropping of the pad into the bottom of the machine for convenient use, to be used in America and abroad for only a small fee of $0.50 to $1.00 per pad, as the price has not been established yet because the chemists have not determine the rate necessary to get a just price for the pad, as this pad is badly needed for sometime now, but thank god late is better than never.
